(19) United States
(12) Patent Application Publication
(10) Pub. No.: US 2009/0277741 A1
(43) Pub. Date: Nov. 12, 2009

(54) HUB AND AXLE ASSEMBLY FOR A BICYCLE

(75) Inventor: Hubert CHEN, Taichung Hsien (TW)

Correspondence Address: FOLEY AND LARDNER LLP;SUITE 500, 3000 K STREET NW, WASHINGTON, DC, 20007, US

(73) Assignee: KUN TENG INDUSTRY CO., LTD.

(21) Appl. No.: 12/206,313

(22) Filed: Sep. 8, 2008

(30) Foreign Application Priority Data
May 12, 2008 (TW) 097117412

(51) Int. Cl. B60B 27/04; F16D 23/00

(52) U.S. Cl. 192/64

(57) ABSTRACT

A hub and axle assembly includes a hub surrounding an axle. An inner surrounding surface of the hub has larger and smaller mounting segments defining therein first and second annular spaces, respectively. A tubular drive member includes a chainring carriage segment spaced apart from the axle by a first bearing mounting groove, a positioning segment which is insertable into the first annular space and which is spaced apart from the larger diameter segment by a second bearing mounting groove, and a pawl mounting segment insertable into the second annular space. A uni-directional mechanism is disposed between the pawl mounting segment and the smaller-mounting segment. First and second rolling-element bearing units are disposed in the first and second bearing mounting grooves, respectively, to stabilize rotation of the chainring carriage segment and the hub relative to the axle.

### CROSS-REFERENCE TO RELATED APPLICATION

This application claims priority of Taiwanese patent Application No. 097117412, filed on May 12, 2008.

### BACKGROUND OF THE INVENTION

1. Field of the Invention

This invention relates to a hub and axle assembly for a bicycle, more particularly to a hub and axle assembly with a uni-directional mechanism mounted within the hub.

2. Description of the Related Art

A conventional free-wheel hub assembly for a bicycle, such as that disclosed in U.S. Pat. No. 6,907,972 B2, includes a uni-directional mechanism disposed between a hub and a chainring carriage member to permit co-rotation of the chainring carriage member with the hub when the bicycle is pedaled in a forward direction. The hub and the chainring carriage member are rotatably mounted to an axle by virtue of a plurality of ball bearings. In addition, a tubular sleeve and a self-lubricating bearing are disposed between the axle and the uni-directional mechanism so as to ensure freewheeling of the hub.

Another free-wheel hub assembly for a bicycle, as disclosed in U.S. Pat. No. 6,827,497 B2, includes a self-lubricating bearing disposed between an axle and a uni-directional mechanism to ensure freewheeling of the hub relative to the axle.

In U.S. Pat. No. 6,386,644 B2, the applicant discloses a bicycle hub which has a uni-directional mechanism disposed within a hub, and a seal member disposed on the uni-directional mechanism at an end side face of the hub to ward off extraneous dirt and moisture.

In the aforesaid bicycle hub assemblies, a plurality of ball bearings are provided to rotatably support the hub and a chainring carriage member relative to an axle. Thus, such bicycle hub assembles do not aim to provide a light-weighted and miniaturized construction for mounting a relatively small chainring.

### SUMMARY OF THE INVENTION

An object of the present invention is to provide a hub and axle assembly for a bicycle which can carry a relatively small chainring and which ensures smooth rotation of a hub and a chainring carriage relative to an axle.

According to this invention, the hub and axle assembly includes an axle and a hub which is rotatable relative to the axle, and which has an inner surrounding surface confronting and spaced apart from the axle. The inner surrounding surface extends to terminate at a surrounding exterior surface facing rightwards, and has a larger mounting segment which cooperates with the axle to define a first annular space, and a smaller mounting segment which cooperates with the axle to define a second annular space. A tubular drive member is rotatably mounted on the axle, and includes a chainring carriage segment which has an inner wall surface spaced apart radially from the axle by a first bearing mounting groove, and an outer wall surface adapted to carry a chainring thereon, a positioning segment which is insertable into the first annular space from the surrounding exterior surface, and which is spaced apart from the larger diameter segment by a second bearing mounting groove, and a pawl mounting segment which is insertable into the second annular space. A uni-directional mechanism is disposed between the pawl mounting segment and the smaller-mounting segment to enable transmission of drive of the tubular drive member to rotate the hub. A first rolling-element bearing unit is disposed in the first bearing mounting groove to stabilize rotation of the chainring carriage segment relative to the axle. A second rolling-element bearing unit is disposed in the second bearing mounting groove, and includes a bushing sleeved on the axle, and a needle rolling bearing disposed between the bushing and the inner wall surface to facilitate rotation of the hub relative to the tubular drive member when the hub is freewheeling.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a partly sectional view of the preferred embodiment of a hub and axle assembly according to this invention;

FIG. 2 is a fragmentary enlarged sectional view of the preferred embodiment; and

FIG. 3 is a cross-sectional view of the preferred embodiment, taken along line III-III of FIG. 1.

### DETAILED DESCRIPTION OF THE PREFERRED EMBODIMENT

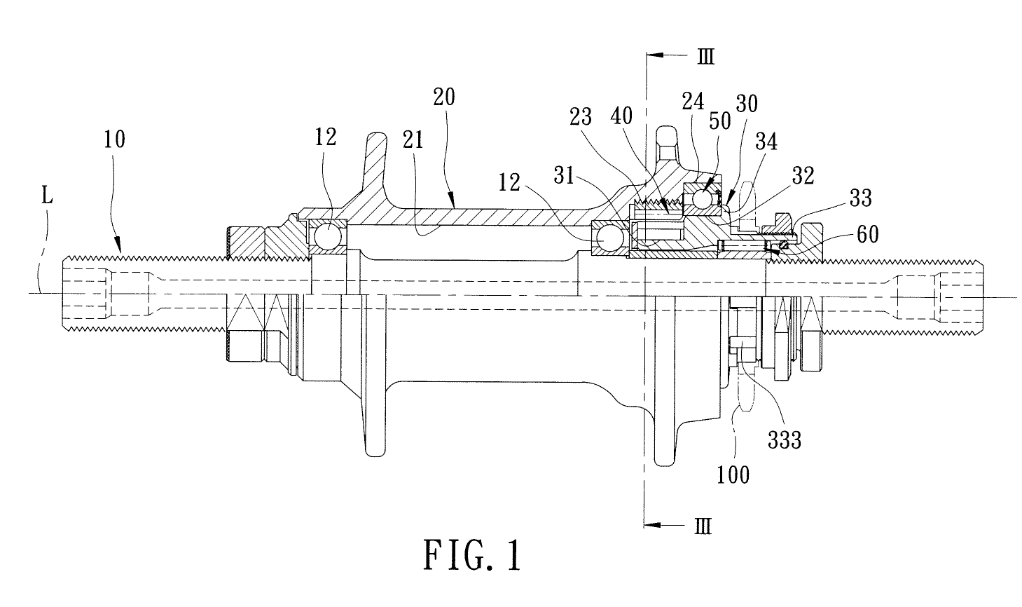

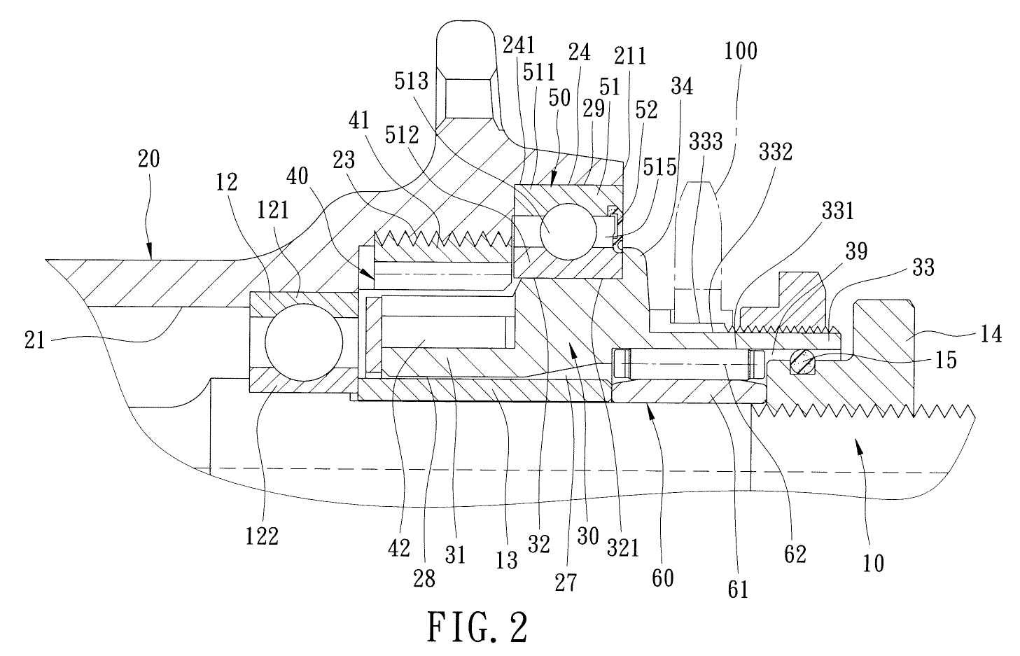

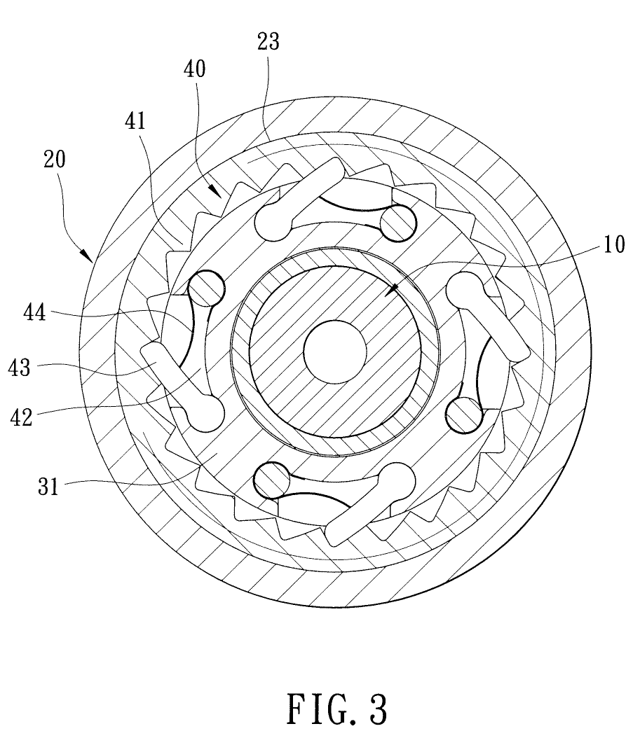

Referring to FIGS. 1 to 3, the preferred embodiment of a hub and axle assembly for a bicycle according to the present invention is shown to comprise an axle 10 extending along an axis (L), a hub 20 rotatably mounted on the axle 10 about the axis (L) through a plurality of inner ball bearings 12, a tubular drive member 30, a uni-directional mechanism 40, and first and second rolling-element bearing units 60,50. The hub 20 has an inner surrounding surface 21 which confronts and which is spaced apart from the axle 10 in radial directions relative to the axis (L) and which extends along the axis to terminate at a surrounding exterior surface 211 that faces rightwards. The inner surrounding surface 21 has a larger mounting segment 24 which extends leftwardly from the surrounding exterior surface 211 and which cooperates with the axle 10 to define a first annular space 27, and a smaller mounting segment 23 which extends leftwardly from the larger mounting segment 24 and which cooperates with the axle 10 to define a second annular space 28.

The tubular drive member 30 is rotatably mounted on the axle 10, and includes a chainring carriage segment 33, a positioning segment 32, and a pawl mounting segment 31.

The chainring carriage segment 33 has an inner wall surface 331 which is spaced apart radially from the axle 10 by a first bearing mounting groove 39, and an outer wall surface 332 opposite to the inner wall surface 331 in radial directions. The outer wall surface 332 has a spline portion 333 in spline engagement with a chainring 100.

The positioning segment 32 extends leftwardly from the chainring carriage segment 33, and is configured to be insertable into the first annular space 27 from the surrounding exterior surface 211. The positioning segment 32 is spaced apart from the larger diameter segment 24 by a second bearing mounting groove 29.

The pawl mounting segment 31 extends leftwardly from the positioning segment 32, and is configured to be insertable into the second annular space 28.

The uni-directional mechanism 40 is disposed between the pawl mounting segment 31 and the smaller-mounting segment 23. Specifically, the uni-directional mechanism 40 includes a ratchet ring 41 which is threadedly engaged with the smaller-mounting segment 23, a plurality of retreat bores 42 which are formed in a peripheral surface of the pawl mounting segment 31, and a plurality of pawls 43 which are received respectively in the retreat bores 42 and which are biased respectively by springs 44 to engage the ratchet ring 41 when the bicycle is pedaled in a forward direction so as to enable transmission of drive of the tubular drive member 30 to rotate the hub 20.

The first rolling-element bearing unit 60 is disposed in the first bearing mounting groove 39, and includes a bushing 61 sleeved on the axle 10, and a needle rolling bearing 62 disposed between the bushing 61 and the inner wall surface 331, thereby stabilizing rotation of the chainring carriage segment 33 relative to the axle 10.

The second rolling-element bearing unit 50 is disposed in the second bearing mounting groove 29 to facilitate rotation of the hub 20 relative to the tubular drive member 30 when the hub 20 is freewheeling. The second rolling-element bearing unit 50 includes a ball bearing 51 which has outer and inner races 511,512 that are disposed respectively on the larger mounting segment 24 and the positioning segment 32, and that respectively have right lateral edges defining an annular clearance 515 therebetween, and a plurality of balls 513 interposed between the outer and inner races 511,512 such that the balls 513 are exposed rightwardly through the annular clearance 515. The second rolling-element bearing unit 50 further includes a surrounding shielding member 52 which is configured to be fitted in the annular clearance 515 and which is in water-tight engagement with the outer and inner races 511,512 to ward off extraneous dirt and moisture.

Further, the tubular drive member 30 includes an annular barrier 34 which extends radially and outwardly from the positioning segment 32, and which is disposed rightwardly of the inner race 512 of the ball bearing 51 to prevent axial movement of the ball bearing 51.

One of the inner ball bearings 12 is disposed leftwardly of the pawl mounting segment 31 of the tubular drive member 30, and has outer and inner races 121,122 disposed respectively on the inner surrounding surface 21 of the hub 20 and the axle 10.

Preferably, a tubular spacer 13 is sleeved on the axle 10, and is disposed between the inner race 122 of the inner ball bearing 12 and the bushing 61 such that the tubular spacer 13 is forced by the bushing 61 to abut against the inner race 122, thereby guarding against axial movement of the inner ball bearing 12.

Further, a screw nut 14 is threadedly engaged with the axle 10 so as to be movable into the first bearing mounting groove 39, thereby enabling the bushing 61 to force the tubular spacer 13 towards the inner ball bearing 12. Furthermore, an O-ring 15 is disposed between the screw nut 14 and the inner wall surface 331 of the chainring carriage segment 33 so as to provide water-tight engagement therebetween.

As illustrated, according to the preferred embodiment, the tubular drive member 30, which has the chainring carriage segment 33 for carrying the chainring 100, can be supported steadily on the axle 10, and is smoothly rotatable relative to the hub 20 by virtue of the arrangement of the second rolling-element bearing unit 50. In addition, by virtue of the provision of the first rolling-element bearing unit 60, which includes the needle bearing 62, the chainring carriage segment 33 can be configured to have a decreased outer diameter, so that the chainring 100 in spline engagement with the chainring carriage segment 33 can be relatively small and light-weighted.

It is noted that, since the second rolling-element bearing unit 50 is prevented from axial movement by the annular barrier 34, and since the surrounding shielding member 52 is fitted in the annular clearance 515 in the second rolling-element bearing unit 50 to ward off extraneous dirt and moisture, there is no need to provide a specific seal member such as that of the bicycle hub disclosed in U.S. Pat. No. 6,386,644 B2.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A hub and axle assembly for a bicycle, comprising:
an axle extending along an axis;
a hub rotatably mounted on said axle about the axis, and having an inner surrounding surface which confronts and which is spaced apart from said axle in radial directions relative to the axis and which extends along the axis to terminate at a surrounding exterior surface that faces rightwards, said inner surrounding surface having a larger mounting segment which extends leftwardly from said surrounding exterior surface and which cooperates with said axle to define a first annular space, and a smaller mounting segment which extends leftwardly from said larger mounting segment and which cooperates with said axle to define a second annular space;
a tubular drive member rotatably mounted on said axle, and including
a chainring carriage segment which has an inner wall surface that is spaced apart radially from said axle by a first bearing mounting groove, and an outer wall surface opposite to said inner wall surface in radial directions, and adapted to carry a chainring thereon,
a positioning segment which extends leftwardly from said chainring carriage segment and which is configured to be insertable into said first annular space from said surrounding exterior surface, said positioning segment being spaced apart from said larger diameter segment by a second bearing mounting groove, and
a pawl mounting segment which extends leftwardly from said positioning segment and which is configured to be insertable into said second annular space;
a uni-directional mechanism disposed between said pawl mounting segment and said smaller-mounting segment to enable transmission of drive of said tubular drive member to rotate said hub;
a first rolling-element bearing unit disposed in said first bearing mounting groove to stabilize rotation of said chainring carriage segment relative to said axle; and
a second rolling-element bearing unit disposed in said second bearing mounting groove, and including a bushing sleeved on said axle, and a needle rolling bearing disposed between said bushing and said inner wall surface to facilitate said hub to rotate relative to said tubular drive member when said hub is freewheeling.

2. The hub and axle assembly as claimed in claim 1, wherein said second rolling-element bearing unit includes
a ball bearing having outer and inner races which are disposed respectively on said larger mounting segment and said positioning segment and which respectively have right lateral edges that define an annular clearance therebetween, and a plurality of balls interposed between said outer and inner races such that said balls are exposed rightwardly through said annular clearance, and
a surrounding shielding member which is configured to be fitted in said annular clearance and which is in water-tight engagement with said outer and inner races to ward off extraneous dirt.

3. The hub and axle assembly as claimed in claim 2, wherein said tubular drive member further includes an annular barrier which extends radially and outwardly from said positioning segment and which is disposed rightwardly of said inner race of said ball bearing to prevent axial movement of said ball bearing.

4. The hub and axle assembly as claimed in claim 1, further comprising an inner ball bearing which has outer and inner races disposed respectively on said inner surrounding surface of said hub and said axle so as to facilitate rotation of said hub relative to said axle, said inner ball bearing being disposed leftwardly of said pawl mounting segment.

5. The hub and axle assembly as claimed in claim 4, further comprising a tubular spacer which is sleeved on said axle and which is disposed between said inner race of said inner ball bearing and said bushing such that said tubular spacer is forced by said bushing to abut against said inner race, thereby guarding against axial movement of said inner ball bearing.

6. The hub and axle assembly as claimed in claim 5, further comprising a screw nut which is threadedly engaged with said axle so as to be movable into said first bearing mounting groove, thereby enabling said bushing to force said tubular spacer towards said inner ball bearing.

7. The hub and axle assembly as claimed in claim 6, further comprising an O-ring disposed between said screw nut and said inner wall surface of said chainring carriage segment so as to provide water-tight engagement therebetween.
